(19) United States
(12) Patent Application Publication
(10) Pub. No.: US 2006/0225794 A1
(43) Pub. Date: Oct. 12, 2006

(54) VENT AND RELIEF VALVE

(75) Inventors: Robert H. REINICKE, Mission Viejo, CA (US); David J. SCHROEPFER, Trinidad, CO (US)

Correspondence Address: MCNEES, WALLACE & NURICK LLC, 100 PINE STREET, P.O. BOX 1166, HARRISBURG, PA, 17108-1166, US

(73) Assignee: Circle Seal Controls, Inc., Corona, CA (US)

(21) Appl. No.: 11/278,868

(22) Filed: Apr. 6, 2006

Related U.S. Application Data
(60) Provisional application No. 60/668,717, filed on Apr. 6, 2005.

(51) Int. Cl. F16K 5/10

(52) U.S. Cl. 137/614.17

(57) ABSTRACT

A vent and relief valve having a valve body that is in fluid communication with the interior of a tank containing a fluid. A vent valve and relief valve are positioned within the valve body. The vent valve is capable of being configured into an open position to vent fluid from the interior of the tank. The relief valve is capable of being configured into an open position to relieve pressure within a tank. The relief valve is also capable of engaging the vent valve to form a seal to substantially prevent fluid from flowing from the tank. The valve body also includes a valve seat having a first surface that releasably engages the vent valve when the vent valve is in a closed position and a second surface that releasably engages the relief valve when the relief valve is in a closed position.

### FIELD OF THE INVENTION

The present invention is directed to coaxial flow vent and relief valves for pressurized fluid tanks, ullages and ducts. In particular, the present invention is directed, but not limited to, vent and relief valves for use in cryogenic liquefied gases and hydrocarbon fuel space launch vehicle rocket propellant tank applications.

### BACKGROUND OF THE INVENTION

Pressurized propellant tanks, including tanks for storage of cryogenic liquefied gases, such as oxygen and hydrogen, and liquid hydrocarbons, such as kerosene, generally include a vent opening at the top thereof. Vent and relief valves are typically mounted on the top of the tanks. Alternatively, the vent and relief valves are mounted in the discharge vents of the tanks. The vent and relief valves provide a vent function and a pressure relief function. The vent function includes the ability for the vent and relief valve to vent the tank, such as during the filling of the tank or when it is otherwise desirable to release large quantities of gas from the tank. Launch vehicle propellant tanks are usually pressurized to enhance the structural stability of the tanks, and to ensure a net positive suction head (NPSH) to prevent cavitation of the turbopumps that are generally used in these systems. The relief function provides pressure relief to avoid overpressurization of the tank when the vent is closed. The relief function allows safe operation of the tank by maintaining the pressure of the tank below a predetermined, safe pressure.

One known form of vent and relief valve is a non-coaxial flow device containing a main valve member that axially slides in a bore of the valve body and which is linked to an actuator operated by externally applied gas, such as helium. When pressurized with gas, the actuator moves the main valve open to vent the tank of ullages gas and/or cryogenic liquid boil-off gas, such as during the filling of the tank with a liquid cryogenic fuel or propellant. Alternately, the relief valve modulates to an open position by action of an integral pilot valve and actuator piston to automatically prevent tank pressure from exceeding a predetermined value. This known form of vent and relief valve is often mounted on top of and outside of a tank, requiring vertical installation space. The non-coaxial flow path around the main flow element is tortuous and significantly impedes flow exhausting from the tank. Only a single outlet port can be conveniently and practically incorporated in this known form of vent and relief valve, so an additional flow splitter must be added at the valve outlet to direct flow into two diametrically opposing discharge exhausts to mitigate side thrust on the tank. It also is possible that the main valve could jam or stick in the sliding bore of the body as a result of cyclic wear induced material galling, particulate contamination, thermal distortion or any combination thereof. This single point failure would cause both the vent and relief operating modes to be degraded or totally inoperative, allowing the possibility of overpressurization and catastrophic failure of the tank.

Another vent and relief valve known in the art includes the coaxial vent and relief valve disclosed in U.S. Pat. No. 3,945,295 to Reinicke, which is herein incorporated by reference in its entirety. In the Reinicke patent, a vent valve and relief valve are arranged coaxially in the valve body to minimize the flow impedance of non-coaxial vent and relief valves. The vent valve and relief valve have interengaged seats to prevent escape of pressurized fluid. In particular, the Reinicke patent includes a poppet vent valve which seats against a relief bellows seat. Engagement of the poppet against the bellows seat provides the seal preventing the flow of fluid through the valve. During vent mode operation, the poppet disengages from the bellows seat through the operation of an externally gas pressurized actuator and provides a space through which fluid is permitted to flow. Alternately, during relief mode operation, when the pressure within the tank exceeds a pre-determined pressure, the interior of the dual bellows is reduced in pressure by the venting action of the pilot valve, creating a pressure differential that compresses the bellows, disengaging the bellows seat from the poppet valve, allowing fluid to travel through the valve and preventing pressure buildup in the tank. The venting continues until the tank pressure is reduced to the desired level. The Reinicke patent valve does not have a single point failure that can simultaneously disable both the relief and vent operating modes, which increases reliability in critical space vehicle applications. The Reinicke patent valve has the drawback that the bellows of the relief valve are not protected from damage, particularly during installation into the tank. Further, the Reinicke patent has independent and separate travel stops for the vent mode poppet and relief mode seat, making valve assembly and adjustment more tedious and providing for a less consistent and reliable operation under thermal transient conditions. The Reinicke patent also has the drawback that it has a single outlet providing for a valve having a relatively large height from the top of the tank, taking up valuable space, for example, in a space launch vehicle. The single outlet has the further disadvantage that a side thrust force is created during the vent and/or relief functions of the valve due to the fluid exhausting from the single outlet duct, and a special flow splitter with diametrically opposing outlets must be added to mitigate side thrust force.

What is needed is a vent and relief valve that is more compact, that provides for easier assembly and more precise travel stop settings, that provides more consistent operation under thermal transient conditions, that provides protection for the relief valve mechanism during installation, that more conveniently mitigates side thrust, and that does not suffer from the drawbacks of the prior art.

### SUMMARY OF THE INVENTION

The present invention includes a vent and relief valve, particularly for use with cryogenic liquefied gas and hydrocarbon fuel storage tanks. The vent and relief valve has a valve body that is in fluid communication with the interior of a tank containing a fluid. A valve body includes a vent valve and a relief valve. The vent valve is capable of being configured into an open position to vent fluid from the interior of the tank. The relief valve is capable of being configured into an open position to relieve pressure within the tank when the pressure within the tank exceeds a predetermined pressure. The relief valve is also capable of engaging the vent valve to form a seal to substantially prevent fluid from flowing from the tank. The vent valve and relief valve are positioned in a coaxial configuration. The vent and relief valve also includes a valve seat having a first surface that releasably engages the vent valve when the vent valve is in a closed position. The valve seat further includes a second surface that releasably engages the relief valve when the relief valve is in a closed position.

The present invention also includes an embodiment of a vent and relief valve having a plurality of outlet ducts. The vent and relief valve according to this embodiment has a valve body that is in fluid communication with the interior of a tank containing a fluid. A valve body includes a vent valve and a relief valve. The vent valve is capable of being configured into an open position to vent fluid from the interior of the tank. The relief valve is capable of being configured into an open position to relieve fluid pressure within the tank when the fluid pressure within the tank exceeds a predetermined pressure. The relief valve is also capable of engaging the vent valve to form a seal to substantially prevent fluid from flowing from the tank. The vent valve and relief valve are positioned in a coaxial configuration. The vent and relief valve also includes a valve seat having a first surface that releasably engages the vent valve when the vent valve is in a closed position. The vent and relief valve further includes a second surface that releasably engages the relief valve when the relief valve is in a closed position. The vent and relief valve further includes a plurality of outlet ducts in fluid communication with the valve body. The outlet ducts allow discharge of fluid when either or both of the vent valve and relief valve are in the open position.

The present invention also includes an embodiment of a vent and relief valve having a plurality of outlet ducts and an actuator mechanism that is at least partially recessed into the valve body. The vent and relief valve according to this embodiment has a valve body that is in fluid communication with the interior of a tank containing a fluid. A vent valve is positioned within the valve body. The vent valve is capable of being configured into an open position to vent fluid from the interior of the tank. A relief valve is also positioned within the valve body. The relief valve is capable of being configured into an open position to relieve pressure within the tank when the pressure within the tank exceeds a predetermined pressure. The relief valve is also capable of engaging the vent valve to form a seal to substantially prevent fluid from flowing from the tank. The vent valve and relief valve are positioned in a coaxial configuration. The vent and relief valve also includes a valve seat having a first surface that releasably engages the vent valve when the vent valve is in a closed position. The vent and relief valve further includes a second surface that releasably engages the relief valve when the relief valve is in a closed position. The vent and relief valve further includes a plurality of outlet ducts in fluid communication with the valve body. The outlet ducts allow discharge of fluid when either or both of the vent valve and relief valve are in the open position.

The present invention further includes a method for venting or relieving pressure on a tank. The method includes providing a tank for storage of cryogenic liquefied gases and a vent and relief valve in communication with the interior of the tank. The valve and relief valve have a vent valve and relief valve being arranged and disposed in a coaxial configuration. A pressure in the interior of the tank is sensed. The relief valve is configured into an open position in response to a predetermined pressure sensed in the interior of the tank. The relief valve is configured into a closed position in contact with a valve seat when the sensed pressure in the interior of the tank is less than the predetermined pressure. The vent valve is configured into an open position when venting of cryogenic liquefied gases from the interior of the tank is desired. The vent valve is configured into a closed position when no venting of cryogenic liquefied gases from the interior of the tank is desired.

An advantage of the present invention is that the dual stop guard provides a stop for both the relief valve and a stop for the vent valve.

Another advantage of the present invention is that the dual stop guard provides protection for the relief valve, particularly during installation. In particular, the embodiment of the invention including metallic bellows in the relief valve are protected from damage.

Still another advantage of the present invention is that the dual stop guard permits the valves to seat against each other and provide an improved seal, while still providing a stop for both the vent valve and the relief valve.

Still another advantage of the present invention is that the multiple outlet provides smaller outlet ducts from the valve. Smaller outlet ducts permit the valve to have a reduced height, while maintaining relief and vent capacity. The reduced height reduces the space required for the valve and allows a greater amount of area for other components in an application such as a space launch vehicle.

Still another advantage of the present invention is that the multiple outlet ducts provides fluid relief resulting in reduced side or internal thrust. In one embodiment having a dual outlet duct, the thrust may be equalized in order to substantially prevent thrust in a single direction.

Still another advantage of the present invention is that the multiple outlet ducts provides an increased area of venting, allowing the recess of the actuator into the valve further reducing the height of the valve. The reduced height reduces the space required for the valve and allows a greater amount of area for other components for the launch vehicle.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a vent and relief valve according to an embodiment of the present invention.

FIG. 2 is a cutaway schematic view of a vent and relief valve in a closed position according to an embodiment of the present invention.

FIG. 3 is a cutaway schematic view of the vent and relief valve shown in FIG. 2 with the vent valve in an open position.

FIG. 4 is a cutaway schematic view of the vent and relief valve shown in FIG. 2 in pressure relief position.

FIG. 5 is a cutaway schematic view of a vent and relief valve in a closed position according to an alternate embodiment of the present invention.

FIG. 6 is a cutaway schematic view of the vent and relief valve shown in FIG. 5 with the vent valve in an open position.

FIG. 7 is a cutaway schematic view of the vent and relief valve shown in FIG. 5 in a pressure relief position.

FIG. 8 is a cutaway schematic view of a vent and relief valve according to an alternate embodiment of the present invention.

FIG. 9 is a cutaway schematic view of a vent and relief according to an alternate embodiment of the present invention.

Wherever possible, the same reference numbers will be used throughout the drawings to refer to the same or like parts.

### DETAILED DESCRIPTION OF THE INVENTION

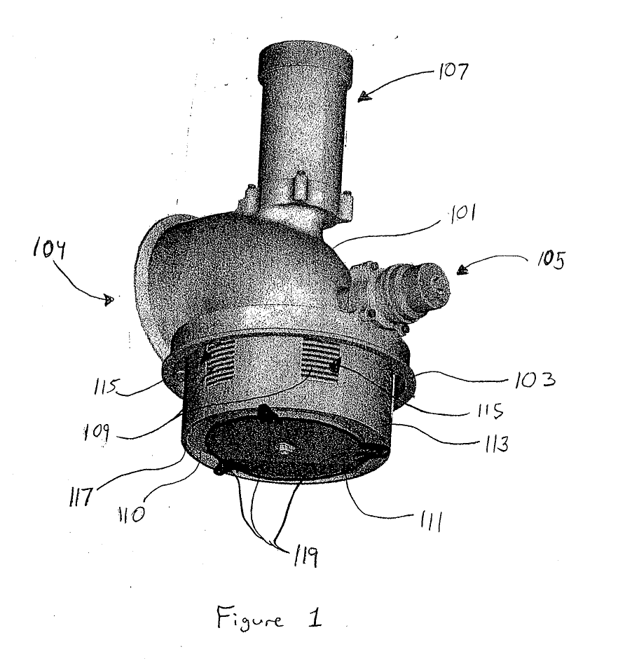

FIG. 1 shows a perspective view of a vent and relief valve according to an embodiment of the present invention. The vent and relief valve includes a valve body 101 which attaches to a tank (not shown) by attachment flange 103. The tank may contain a pressurized fluid, such as, for example, cryogenic liquefied oxygen, hydrogen, or hydrocarbon liquid, such as kerosene. The valve body 101 also includes a pilot valve 105 that operates a relief valve 109. The relief valve 109 is a bellows structure having a relief valve seat portion 110 that is capable of being drawn up into an open position to release fluid from the tank gas ullages. The valve body 101 further includes an actuator mechanism 107 that operates a vent valve 111. The vent valve 111 is a poppet valve that extends from the base of the valve which is adjacent to the fluid in the tank upward toward the valve body 101 into the actuator mechanism 107. A valve stop 113 is coaxial positioned coaxially with respect to the relief valve 109 and the vent valve 111 and provides protection for the relief valve 109. The valve stop 113 provides a structure that prevents the bellows of the relief valve 109 from contacting the tank or other equipment during installation, reducing the chances that the bellows is damaged or punctured. The valve stop 1 13 extends from the valve body 101 into the tank from the attachment flange 103. The valve stop 113 includes openings 115, which permit flow of fluid from the tank when the relief valve is in the open position. The configuration of the openings can be any configuration of openings that permits fluid to pass, particularly when the valve is in the relief position. Preferably, the valve includes openings at least partially circumferentially around the valve stop. When the vent valve 111 and/or relief valve 109 are in the open position, fluid travels through the valve body 101 and exhausts through an outlet duct 104. FIG. 1 shows the vent valve 111 in a closed position. The vent valve 111 includes a plurality of vent valve tangs 119, which extend outward from the center axis of the vent valve. The valve stop 113 also includes a vent valve stop surface 117, which releasably engages vent valve tangs 119. When the vent valve 111 is in the closed position, the vent valve tangs 119 engage the valve stop surface 117 and maintain the position of the vent valve 111. The actuator mechanism 107 preferably provides an upward force on the vent valve 111 when the vent valve 111 is not activated to maintain engagement of vent valve tangs 119 and the vent stop surface 117. The relief valve seat portion 110 engages the vent valve 111 and provides a seal that substantially prevents the flow of fluid through the valve. The separate actuator mechanism 107 and pilot valve 105 permits independent operation of each of the vent valve 111 and the relief valve 109. Although FIG. 1 shows the vent and relief valve in the closed position, either or both of the vent valve 111 or relief valve 109 may be moved to release fluid from the tank.

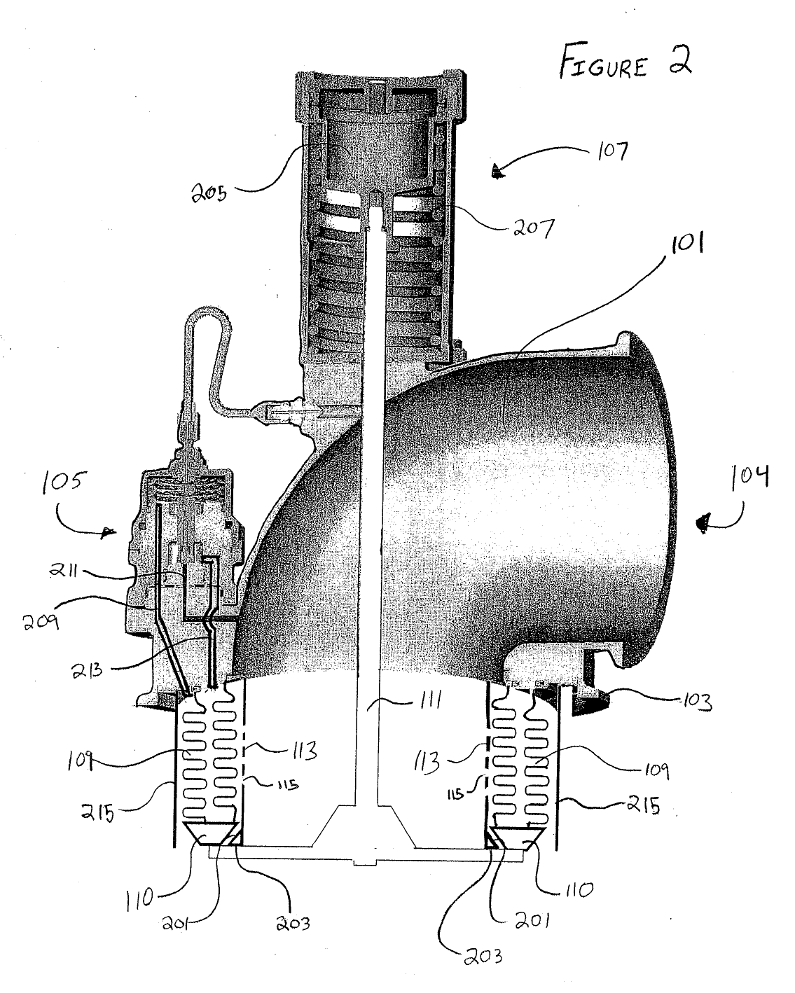

FIG. 2 shows a vent and relief valve in a closed position according to one embodiment of the present invention. As in FIG. 1, the vent and relief valve includes a valve body 101, which is mounted on a tank by attachment flange 103. The vent and relief valve includes a vent valve 111 and a relief valve 109 positioned in a coaxial arrangement. Unlike the embodiment shown in FIG. 1, the valve stop 113 forms a cylinder encircled by the relief valve 109. Similar to the embodiment shown in FIG. 1, the valve stop 113 includes one or more openings (not shown in FIG. 2) that permit the flow of fluid through the valve when the relief valve 109 is in the open position. The valve stop includes a relief valve stop surface 201 and a vent valve stop surface 203. The relief valve stop surface 201 provides a surface that releasably engages the relief valve seat portion 110 and prevents the relief valve 109 from opening further when the relief valve is in the fully open position. The vent valve stop surface 203 provides a surface that releasably engages the vent valve 111 and prevents the vent valve from closing further when the vent valve is in the closed position.

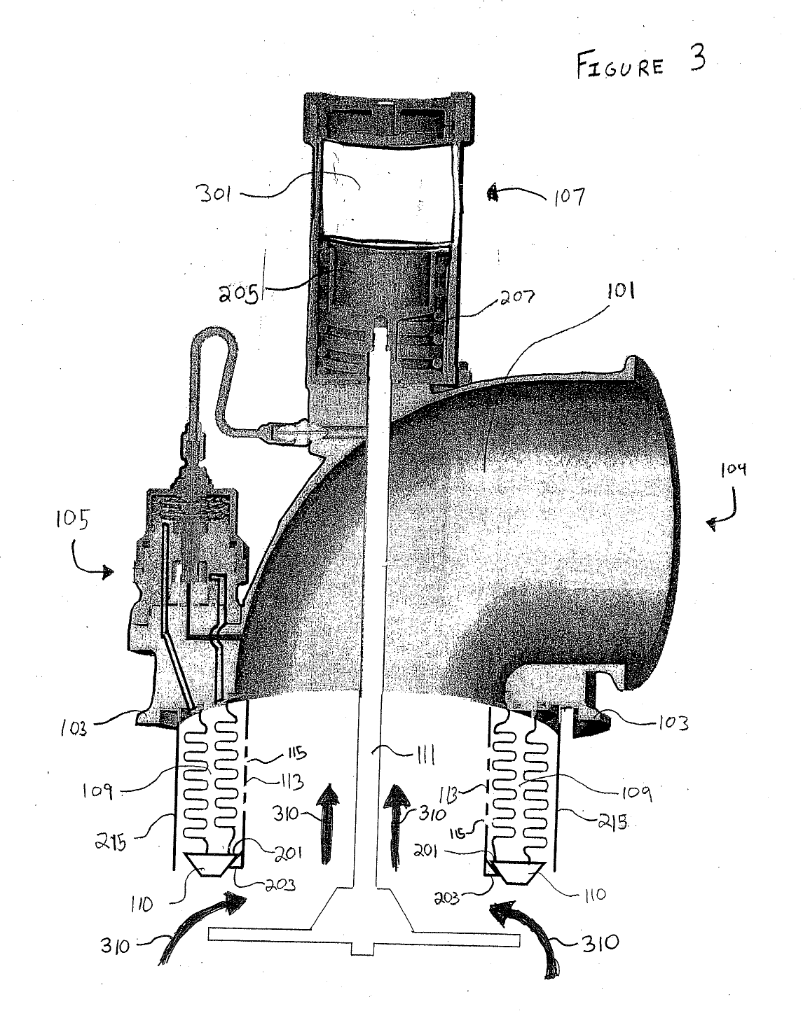

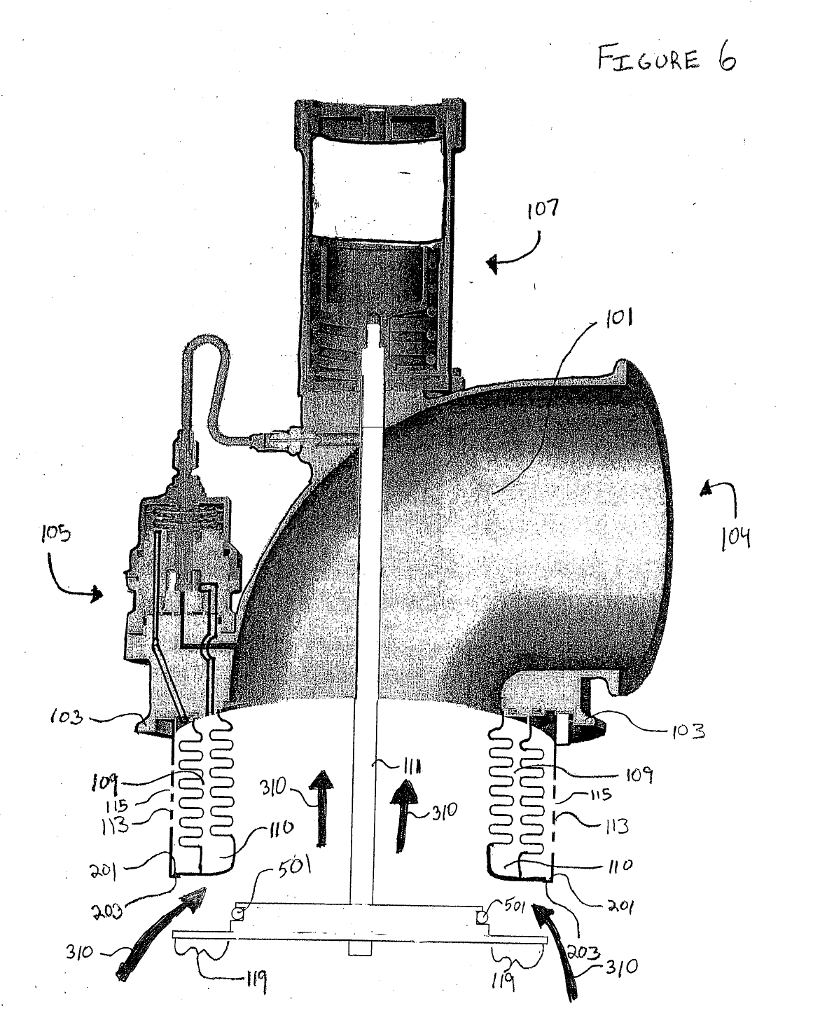

FIG. 2 shows the vent and relief valve in the closed position, where the relief valve seat portion 110 engages the vent valve 111 and forms a seal that substantially prevents the flow of fluid from the tank through the vent and relief valve. Also, the vent valve 111 engages the vent valve stop surface 203. The vent valve 111 is positioned by use of an actuator 107. The actuator mechanism 107 includes a piston 205 and a spring 207. The spring 207 provides a force urging the vent valve 111 toward the valve stop 113 when the actuator mechanism 107 is not activated. To activate the actuator mechanism 107, a fluid, such as helium or air, is allowed to flow into the piston 205, generating a force for urging the piston toward the attachment flange 103, compressing the spring 207. As the piston 205 moves, the vent valve 111 likewise moves and disengages from the vent valve stop surface 203 of the valve stop 113 (see FIGS. 3 and 6). To close the vent valve 111, a sufficient amount of the fluid in the piston is permitted to escape and the spring overcomes the piston fluid force, the spring decompressing to draw the vent valve 111 toward the valve stop 113, until the vent valve 111 engages the vent valve stop surface 203. Although the actuator 107 is shown as a piston 205 and spring 207 arrangement, the actuator mechanism 107 may be any device that is capable of positioning the vent valve 111 in an open or closed position. The vent valve 111 may be fabricated from any suitable material that can be formed into a poppet valve and can operate in cryogenic temperatures. The vent valve is preferably fabricated from a metal, such as nickel-based superalloy, aluminum alloy, titanium alloy, stainless steel or combinations thereof.

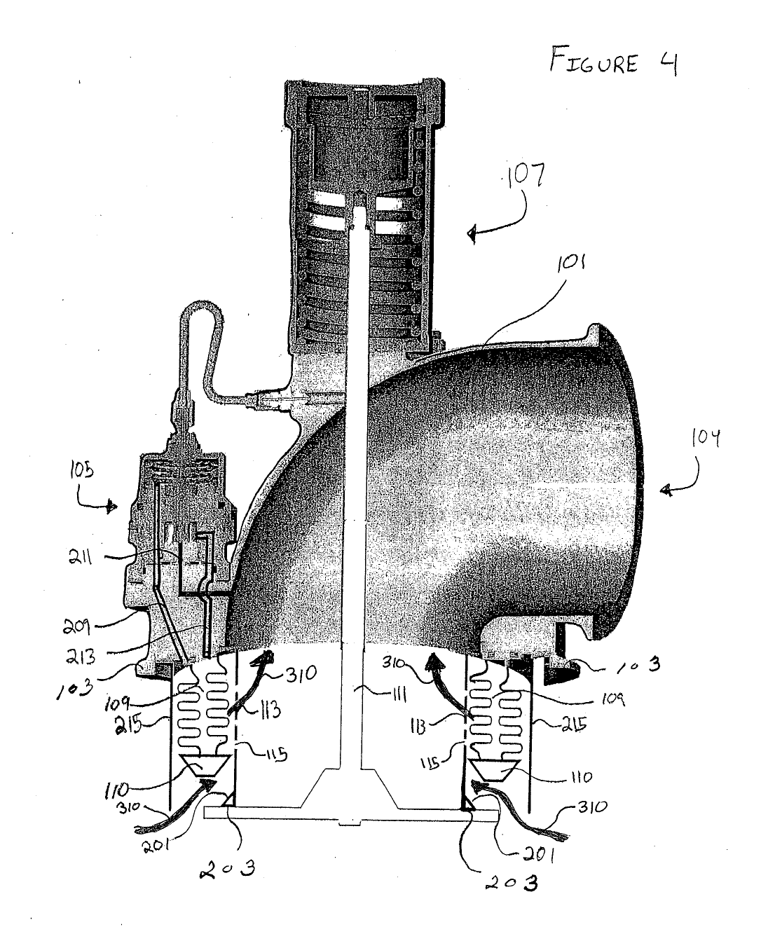

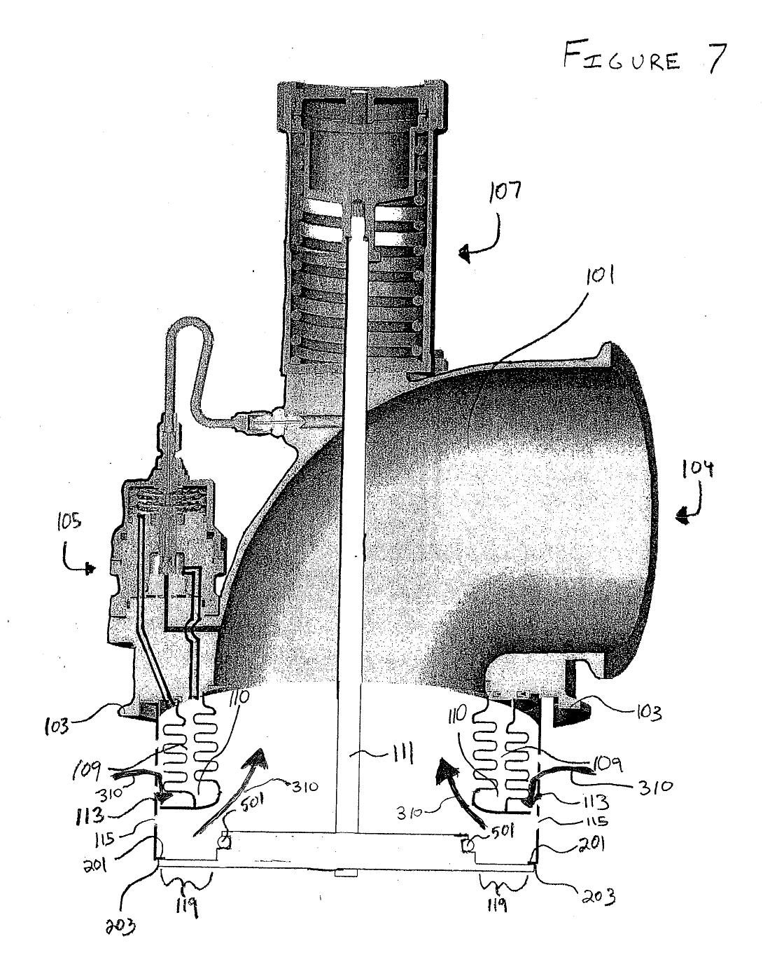

The valve body 101 also includes a relief valve 109. The relief valve 109 includes a bellows arrangement, forming a cylinder coaxial with the vent valve 111. The bellows arrangement of the relief valve 109 is preferably a metallic bellows capable of opening and closing (i.e., contracting and expanding) in response to fluid pressure within the bellows to permit or prevent the flow of fluid from the tank. The relief valve 109 may be fabricated from any suitable material that can be formed into a bellows and can operate in cryogenic temperatures. However, the relief valve is preferably fabricated from a metal, such as nickel-based superalloys, aluminum alloy, titanium alloy, stainless steel, or combinations thereof. The relief valve 109 further includes relief valve seat portion 11 0. When the relief valve 111 is in the fully open position, the relief valve seat portion 110 is engaged on the relief valve stop surface 201. Pilot valve 105 senses the pressure within the tank through pressure sensing line 209. If the pressure in the tank exceeds a predetermined pressure, the pilot valve 105 opens a pilot vent 211 to bellows vent 213, which exhausts fluid from and reduces the pressure in the interior of the bellows to a level that is less than the tank pressure. This establishes a pressure differential across the bellows as compared to the tank pressure, creating a force that compresses the bellows. In other words, the interior volume of the bellows is reduced. As the bellows contracts, the relief valve 109 and the relief valve seat portion 110 is drawn upward away from the vent valve 111. Once the relief valve 109 disengages from the vent valve 111, fluid above the tank ullages is permitted to travel through the openings in the valve stop 113, through the valve body 101 and out the outlet duct 104 (see FIGS. 4 and 7). Ullages, as used herein, is defined as an amount of fluid that a container lacks of being full. Although FIGS. 2-7 show a pilot valve 105 having a pressure sensing capsule arrangement, the pilot valve 105 may be any valve arrangement that is capable of measuring the pressure within the tank and increasing and decreasing the pressure inside the bellows to expand and contract the bellows of the relief valve 109 in response to the pressure in the tank.

Unlike the embodiment shown in FIG. 1, the embodiment shown in FIG. 2 includes a separate relief valve guard 215, which guides the bellows of the relief valve 109 as the bellows expands and contracts and protects the bellows from damage, particularly from impacts from the tank or other equipment that may occur during installation.

FIG. 3 shows the vent and relief valve shown in FIG. 2 with the vent valve 111 in the open position. FIG. 3 has the substantially the same arrangement of valve body 101, attachment flange 103, pilot valve 105, actuator mechanism 107, relief valve 109, vent valve 111, valve stop 113, and relief valve guard 215 as shown in FIG. 2. FIG. 3 shows the vent valve 111 in the open position. In order for the vent valve 111 to be positioned in the open position, the actuator mechanism 107 is activated. To activate the actuator mechanism 107, a fluid 301, preferably helium gas, is permitted to flow into and pressurize piston 205, urging forcing the piston 205 to compress spring 207, which moves vent valve 111 away from the valve body. As the vent valve 111 moves downward away from the valve body, the relief valve 109 and the relief valve seat portion 110 extend and engage the valve stop 113 at relief valve stop surface 201. As the vent valve 111 disengages from the relief valve seat portion 110, the relief valve 109 and the relief valve seat portion 110 extend and engage the valve stop at relief valve stop surface 201. Once the vent valve 111 disengages from both the vent valve stop surface 203 and the relief valve seat portion 110, fluid 310 from the tank is permitted to flow between the vent valve 111 and the engaged relief valve seat portion 110, through the valve body 101 and out through the outlet duct 104 as shown. The positioning of the vent valve 111 into the open position preferably takes place during the filling or the tank and/or when a large quantity of fluid is to be exhausted from the tank ullages. In an alternate embodiment of the present invention, an increased flow of fluid 310 through the vent and relief valve is achieved when the vent valve is in the open position by drawing the relief valve 109 toward the valve body 101. As the bellows of the relief valve 109 is contracted, the relief valve seat portion 110 is drawn upward toward the valve body 101 providing a greater area for fluid flow from the tank ullages.

FIG. 4 shows the vent and relief valve shown in FIG. 2 with the relief valve 109 in the open position. FIG. 4 has the substantially the same arrangement of valve body 101, attachment flange 103, pilot valve 105, actuator mechanism 107, relief valve 109, vent valve 111, valve stop 113, and relief valve guard 215, as shown in FIG. 2. The pilot valve 105 senses the pressure in the tank through pressure sensing line 209. If the pressure in the tank exceeds a predetermined pressure, the pilot valve opens pilot vent 211 to bellows vent 213, which exhausts fluid from and reduces the pressure inside of the bellows to level that is less than the tank pressure. This creates a pressure differential and force that urges the bellows to contract, which moves the relief valve seat portion 110 upward toward the valve body 101 and away from the vent valve 111 and the relief valve stop surface 201. Once the relief valve seat portion 110 disengages from the vent valve 111, fluid 310 from the tank is permitted to flow between the relief valve seat portion 110 and the vent valve 111, through openings 115 (not shown in FIG. 4) in the valve stop 113. The fluid 310 from the tank travels through the valve body 101 and out of the vent and relief valve through the outlet duct 104. The positioning of the relief valve 109 into the open position preferably takes place when the pressure in the tank exceeds the predetermined pressure desired within the tank. The predetermined pressure is preferably a pressure set for safe operation of the tank.

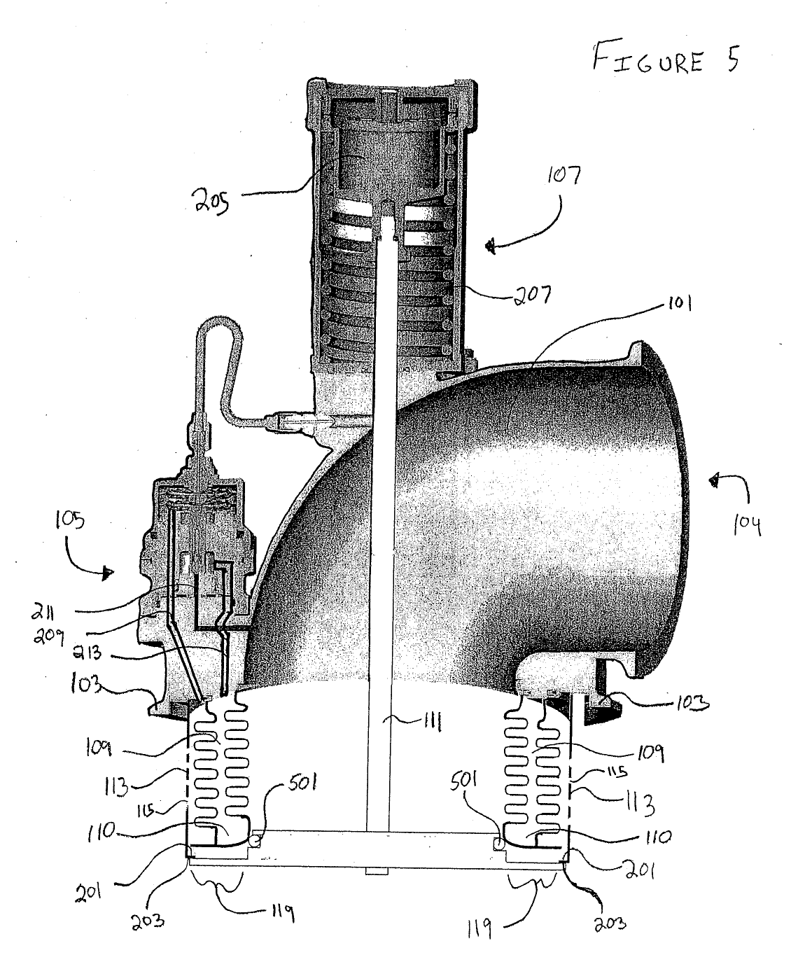

FIG. 5 shows a vent and relief valve in a closed position according to an alternate embodiment of the present invention. FIG. 5 includes a cutaway schematic view of the vent and relief valve shown in FIG. 1. FIG. 5 has the substantially the same arrangement of valve body 101, attachment flange 103, pilot valve 105, actuator mechanism 107, relief valve 109, and vent valve 111, as shown in FIG. 2. The operation of the actuator mechanism 107, including the spring 207 and piston 205 and the pilot valve 105, including the pressuring sensing line 209, the pilot vent 211 and the bellows vent 213, is substantially the same as shown in FIGS. 2-4. However, unlike the embodiment shown in FIGS. 2-4, a valve stop 113 is positioned outside the bellows of the relief valve 109, encircling the relief valve 109 to provide a position to seat the vent valve 111 and the relief valve 109 as well as protection for the bellows of the relief valve 109. Valve stop 113 has a relief valve stop surface 201, which detachably engages the relief valve seat portion 110. The valve stop 113 also has a vent valve stop surface 203, which detachably engages the vent valve 111. The valve stop 113 includes openings 115 (see FIG. 1), which allow the flow of fluid when the relief valve 109 is in the open position. Also unlike FIG. 2, the vent valve includes a plurality of tangs 119, which extend from the vent valve 111. The tangs 119 engage the vent valve stop surface 203 of the valve stop 113 when the vent valve 111 is in the closed position. The tangs 119 may be fabricated in any geometry suitable for engaging vent valve stop surface 203 and positioning the vent valve in the closed position. Although FIG. 1 shows the three tangs 119, any number of tangs 119 may be used, including a solid disk-like geometry extending from the vent valve 111. FIG. 5 shows the vent and relief valve in the closed position, where the vent valve 111 is engaged with the relief valve seat portion 110. The engagement between the vent valve 111 and the relief valve seat portion 110 forms a seal that substantially prevents the flow of fluid through the valve body 101. The embodiment shown in FIG. 5 further includes a ring seal 501, which further improves the seal between the vent valve 111 and the relief valve seat portion 110. The present invention is not limited to the ring seal 501 shown in FIG. 5. The seal may be formed by the direct engagement of the vent valve 111 and the relief valve seat portion 110 or by any suitable seal known in the art. A preferred type of ring seal 501 includes an o-ring, preferably made of a polymer material, such as polytetrafluoroethylene for cryogenic use, and an elastomer, such a fluoroelastomer polymer, for non-cryogenic use.

FIG. 6 shows the vent and relief valve shown in FIG. 5 with the vent valve 111 in the open position. FIG. 6 has substantially the same arrangement of valve body 101, attachment flange 103, pilot valve 105, actuator mechanism 107, relief valve 109, vent valve 111, valve stop 113, and relief valve guard 215 as shown in FIG. 5. The operation of the actuator 107 is substantially the same as the operation shown and described with respect to FIG. 3. As the vent valve 111 is moved downwardly away from the valve body 101, the tangs 119 of the vent valve 111 disengage from the vent valve stop surface 203 of the valve stop 113 and the ring seal 501 of the vent valve 111 disengages from the relief valve seat portion 110. As the vent valve 111 moves downwardly away from the valve body 101, the relief valve 109 and the relief valve seat portion 110 extend and engage the valve stop 113 at relief valve stop surface 201. Once both the tangs 119 and the ring seal 501 are disengaged, fluid 310 is allowed to flow from the tank through the valve body 101 and out through the outlet duct 104. As in FIG. 3, the positioning of the vent valve 111 into the open position, as shown in FIG. 6, preferably takes place during the filling or the tank or when a large quantity of fluid 310 is to be exhausted from the tank ullages. In an alternate embodiment of the present invention, an increased flow of fluid 310 through the vent and relief valve is achieved when the vent valve is in the open position by drawing the relief valve 109 toward the valve body 101. As the bellows of the relief valve 109 is contracted, the relief valve seat portion 110 is drawn upwardly toward the valve body 101 providing a greater area for fluid flow from the tank.

FIG. 7 shows the vent and relief valve shown in FIG. 5 with the relief valve 109 in the open position. FIG. 7 has substantially the same arrangement of valve body 101, attachment flange 103, pilot valve 105, actuator mechanism 107, relief valve 109, vent valve 111, valve stop 113, and relief valve guard 215, as shown in FIG. 5. The operation of pilot valve 105 is substantially the same as the operation shown and described with respect to FIG. 4. If the pressure exceeds a predetermined pressure, the pilot valve 105 exhausts fluid from and reduces the pressure in the interior of the bellows to a level that is less than the tank pressure. This creates a pressure differential across the bellows that contracts the bellows and moves the relief valve seat portion 110 upwardly away from the ring seal 501 portion of the vent valve 111 and the relief valve stop surface 201. Once the relief valve seat portion 110 disengages from the ring seal 501, fluid 310 from the tank ullages is permitted to flow through the openings 115 (see FIG. 1) in the valve stop 113, between the relief valve seat portion 110 and the vent valve 111, through the valve body 101 and out through the outlet duct 104. As in FIG. 4, the positioning of the relief valve 109 into the open position preferably takes place when the pressure in the tank exceeds the predetermined pressure desired within the tank. The predetermined pressure is typically a pressure set for safe operation of the tank.

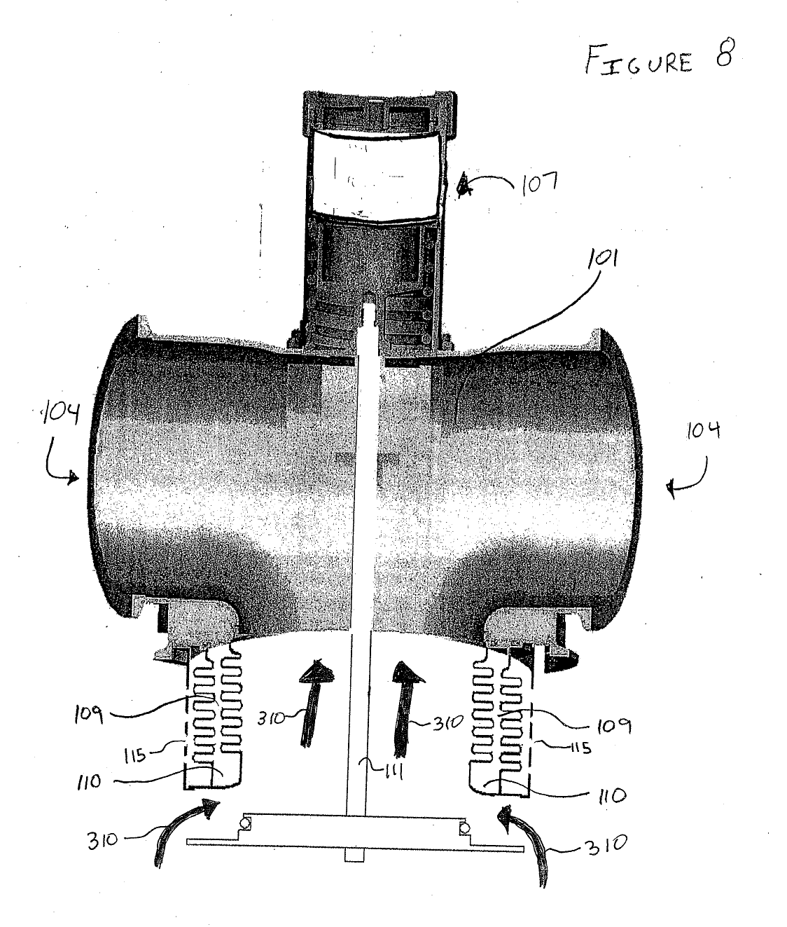

FIG. 8 shows a dual outlet duct, where the outlet duct 104 extends from the center axis of the valve in two opposite directions. When fluid is released, by either or both of the relief valve 109 or the vent valve 111, fluid 310 exits the tank ullages through the valve body 101, and into the outlet duct 104. The outlet duct 104 having the dual outlet permits the flow of fluid 310 to split and exit from the valve in substantially equal portions in each direction. The split flow equalizes any lateral forces due to thrust created by the exit of fluid. The lateral forces of a single outlet can be undesirable in space launch vehicle applications. Therefore, the equalization of the lateral forces is particularly desirable in space launch vehicle applications. In addition to equalizing the force resulting from the exiting fluid, the use of multiple exits for fluid permits each of the individual outlet ducts 104 to be smaller in diameter, where the total capacity to exhaust fluid is at least as large as the single outlet duct 104, as shows in FIGS. 1-7. Since, the diameters of the outlet ducts 104 are smaller, the total height of the vent and relief valve from the surface of the tank is reduced, providing a greater space for other equipment. Greater space for additional equipment is particularly beneficial in launch vehicle applications where space is critical. The vent and relief valve of FIG. 8 also includes a pilot valve 105 (not shown in FIG. 8) preferably mounted at the junction of the multiple outlet ducts 104. Although FIG. 8 shows the flow directed in two directions, any number of outlet ducts may be used, as long as sufficient space near the attachment flange 103 is provided to mount and operate a pilot valve 105 and sufficient symmetry is provided to equalize lateral forces due to exiting fluid. Each additional outlet duct 104 beneficially decreases the height requirement for the valve from the surface of the tank.

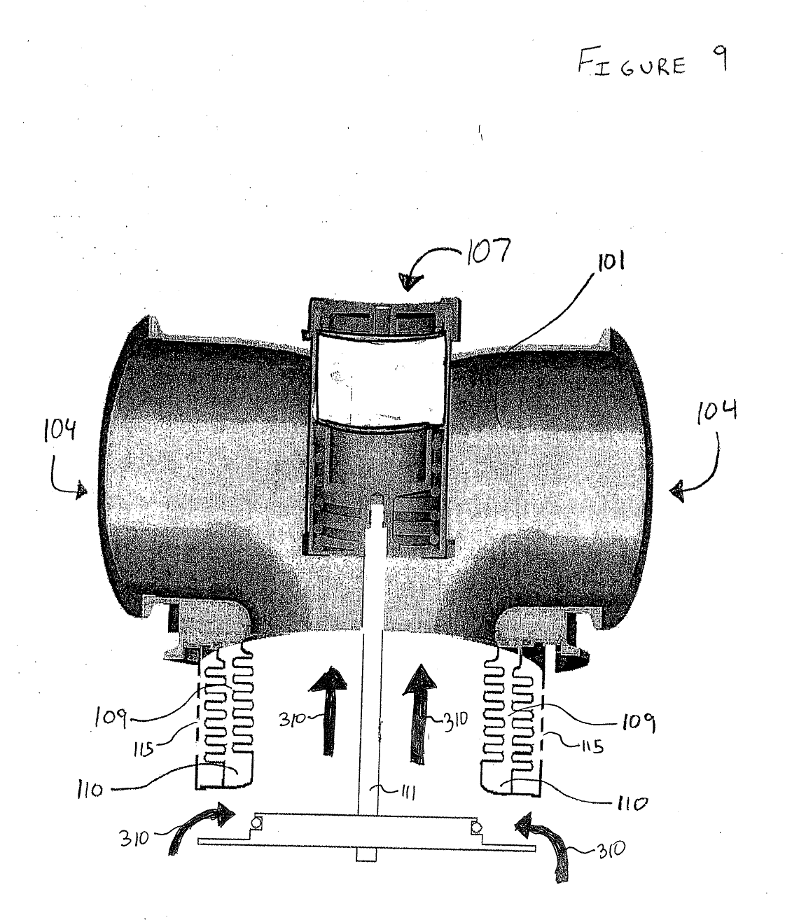

FIG. 9 shows an alternate embodiment of the dual outlet duct, where the actuator mechanism 107 is recessed into the valve body 101. Since the actuator mechanism is recessed into the valve body 101, the total height of the vent and relief valve from the surface of the tank is reduced, providing a greater space for other equipment. Similar to FIG. 8, the vent and relief valve of FIG. 9 also includes a pilot valve 105 (not shown in FIG. 9) preferably mounted at the junction of the multiple outlet ducts 104. Although FIG. 9 shows the actuator mechanism 107 fully recessed into the valve body 101, the actuator mechanism 107 may also be partially recessed to provide increased flow and smaller diameter valve body 101. Further, other components of the vent and relief valve may be recessed into the valve body 101, such as the pilot valve 105 to reduce the amount of space that the valve occupies exterior to the tank.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A vent and relief valve comprising:
a valve body in fluid communication with the interior of a tank containing a fluid comprising:
a vent valve, the vent valve being capable of being configured into an open position to vent fluid from the interior of the tank;
a relief valve, the relief valve being capable of configured into an open position to relieve pressure within the tank when the pressure within the tank exceeds a predetermined pressure, the relief valve also being capable of engaging the vent valve to form a seal to substantially prevent fluid from flowing from the tank;
the vent valve and relief valve arranged and disposed in a coaxial configuration within the valve body; and
the valve body, including a valve seat, having a first surface and a second surface, the first surface releasably engaging the vent valve when the vent valve is in a closed position; and the second surface releasably engaging the relief valve when the relief valve is in a closed position.

2. The valve of claim 1, wherein the relief valve is a bellows capable of expanding or contracting in response to fluid being provided to or removed from the bellows.

3. The valve of claim 2, wherein the bellows comprises a metal selected from the group consisting of nickel-based superalloys, aluminum alloys, titanium alloys, stainless steel and combinations thereof.

4. The valve of claim 1, wherein the vent valve is a poppet valve.

5. The valve of claim 1, wherein the vent valve comprises a metal selected from the group consisting of nickel-based superalloys, aluminum alloys, titanium alloys, stainless steel and combinations thereof.

6. The valve of claim 1, further comprising an outlet duct in communication with the valve body.

7. The valve of claim 6, wherein the outlet duct is arranged to direct fluid in a direction substantially perpendicular to axis of configuration of the vent valve and relief valve.

8. The valve of claim 6, further comprising a plurality of outlet ducts, each outlet duct being in communication with the valve body.

9. The valve of claim 6, further comprising a pilot valve in communication with the relief valve and the interior of the tank, the pilot valve being capable of drawing fluid into or from the relief valve in response to a sensed condition.

10. The valve of claim 1, wherein the vent valve further comprises a plurality of tangs that releasably engage the valve seat when the vent valve is the closed position.

11. The valve of claim 1, further comprising a fluid actuator, the actuator being capable of configuring the vent valve into an open or closed position.

12. The valve of claim 1, wherein the tank is a propellant storage tank for a space launch vehicle.

13. A method for venting or relieving pressure on a tank comprising:
providing a tank for storage of cryogenic liquefied gases;
providing a vent and relief valve in communication with the interior of the tank having a vent valve and a relief valve arranged and disposed in a coaxial configuration;
sensing a pressure in the interior of the tank;
configuring the relief valve into an open position in response to a sensed predetermined pressure in the interior of the tank;
configuring the relief valve into a closed position in contact with a valve seat when the pressure in the interior of the tank is less than the sensed predetermined pressure;
configuring the vent valve into an open position when venting of cryogenic liquefied gases from the interior of the tank is desired; and
configuring the vent valve into a closed position when no venting of cryogenic liquefied gases from the interior of the tank is desired.

14. The method of claim 13, wherein the relief valve is a bellows.

15. The method of claim 14, the method further comprising expanding or contracting the bellows to position the relief valve by providing fluid to or removing fluid from the bellows.

16. The method of claim 13, further comprising exhausting fluid from the interior of the tank through an outlet duct.

17. The method of claim 16, wherein the fluid is directed in a direction substantially perpendicular to an axis of configuration of the vent valve and relief valve.

18. The method of claim 16, further comprising exhausting fluid through a plurality of outlet ducts.

19. The method of claim 13, wherein the method further includes releasably engaging the valve seat when the vent valve is the closed position.

20. The method of claim 13, the method further comprising actuating the vent valve into an open or closed position with a fluid actuator.
